(19) United States
(12) Patent Application Publication
(10) Pub. No.: US 2010/0126795 A1
(43) Pub. Date: May 27, 2010

(54) Electric power steering apparatus for vehicles

(75) Inventor: Hiroyuki Tokunaga, Utsunomiya-shi (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/587,447

(22) Filed: Oct. 7, 2009

(30) Foreign Application Priority Data
Nov. 21, 2008 (JP) 2008-297874

(51) Int. Cl. B62D 5/04

(52) U.S. Cl. 180/446

(57) ABSTRACT

While a steering angle speed which represents a steering speed of the steering wheel is equal to or smaller than a predetermined speed, i.e., while the vehicle is making a steady turn with the steering wheel being held at a given angle or while the vehicle is running straight, when the rate of change of a rack load calculated by a rack load rate-of-change calculator becomes equal to or greater than a predetermined value, an EPS motor is supplied with a corrective current or which serves as a corrective signal for a drive signal in a direction to cancel out the rate of change of the rack load.

### CROSS-REFERENCE TO RELATED APPLICATION

This application is based upon and claims the benefit of priority from Patent Application No. 2008-297874 filed on Nov. 21, 2008, in the Japan Patent Office, of which the contents are incorporated herein by reference.

### BACKGROUND OF THE INVENTION

1. Field of the Invention

The present invention relates to an electric power steering apparatus for transmitting the power of an actuator such as an electric motor or the like to the steering system of a vehicle to reduce the burden on the driver of the vehicle in turning the steering wheel of the steering system.

2. Description of the Related Art

Occasionally, a vehicle travels on a road which is characterized by a fluctuating road surface reaction force applied from the road to the tires of the vehicle, such as a partially icy road. When the front wheels (steerable wheels) of the vehicle enter an icy surface area of the road particularly while the vehicle is making a turn, the coefficient of friction between the tires and the road surface suddenly drops. Therefore, the road surface reaction force applied from the road to the tires abruptly falls, throwing the steering holding force and the road surface reaction force out of balance with each other. As a result, the steering angle tends to increase. As long as the coefficient of friction between the tires and the road surface remains low, the behavior of the vehicle does not change greatly because the lateral forces on the front wheels of the vehicle are not greatly changed by the increasing steering angle. However, when the front wheels of the vehicle run out of the icy surface area and the coefficient of friction between the tires and the road surface starts to increase again, the gripping power of the tires is recovered, and the forces generated on the front wheels increase depending on the increasing steering angle. As a consequence, the behavior of the vehicle is disrupted.

There has been proposed a technology for increasing the stability of a vehicle which incorporates an electric power steering apparatus against abrupt changes in forces generated on the front wheels of the vehicle, as disclosed in Japanese Laid-Open Patent Publication No. 11-049000.

According to the technology disclosed in Japanese Laid-Open Patent Publication No. 11-049000, the steering reaction force exerted on the steering wheel of the vehicle, i.e., the resistive force against the steering force, increases as the rate of change of a rack load becomes greater, thereby reducing the adverse effect on the steering force and the steering holding force when the road surface reaction force abruptly changes. Japanese Laid-Open Patent Publication No. 11-049000 discloses a process of determining the rack load (or its estimated value). A rate of change of the rack load can be determined by differentiating the rack load with respect to time. The rack load is determined by the following equation (1):

Fr=Fp+Fm (1)

where Fr represents the rack load, Fp the rack shaft force from the pinion, and Fm the rack shaft force from the electric motor.

The rack shaft force Fp from the pinion is determined as a value produced by dividing the steering torque Ts by the pitch circle radius rp of the pinion (Fp=Ts/rp). The rack shaft force Fm from the electric motor is determined as a value produced by multiplying the output shaft torque Tm of the electric motor by the output gear ratio N of the electric motor (Fm=N·Tm). The output shaft torque Tm of the electric motor is determined by the following equation (see paragraphs [0020]-[0026] of Japanese Laid-Open Patent Publication No. 11-049000):

Tm=Kt·Im−Jm·θm″−Cm·θm′±Tf

where

Kt: motor torque constant

Im: motor current

Jm: moment of inertia of the rotating portion of the motor (designed value·constant)

θm′: motor angular velocity

θm″: motor angular acceleration (differential value of motor angular velocity θm′)

Cm: coefficient of viscosity of the motor

Tf: friction torque

The motor angular velocity θm′ is determined from the counter-electromotive force of the motor by the following equation:

θm′=(Vm−Im·Rm)/Km

where

Vm: motor voltage (output from the voltage sensor 31)

Rm: motor resistance (designed value·constant)

Km: induction voltage constant of the motor

The motor angular velocity θm′ is also determined from the differential value θs′ of the steering angle θs which is represented by the output from a steering angle sensor which detects the angular displacement of the steering shaft, by the following equation:

θm′=(θs′−Ts′/Ks)N

where

Ks: spring constant of the torque sensor

Ts′: differential value of the steering torque Ts

Practically, the rack shaft force Fp from the pinion and the rack shaft force Fm from the electric motor may be processed by a phase compensation filter to correct any phase shift between these rack shaft forces Fp, Fm.

The electric power steering apparatus is basically designed such that as the vehicle speed is lower, the amount of assistance given by the electric motor to the steering force (steering torque) generated by the steering wheel, i.e., the motor current that is supplied to the electric motor, is greater.

Specifically, in the electric power steering apparatus, the steering assistive force generated by the electric motor to assist in turning the steering wheel is determined based on the detected value of the steering torque and the vehicle speed. Therefore, while the vehicle is making a steady turn, i.e., while the driver is holding the steering wheel at a given angle, the electric power steering apparatus fails to sufficiently block fluctuations of the steering force on the steering wheel which are caused by so-called steering kickback (strong reaction transmitted to the steering wheel when the vehicle runs on rough road surfaces) and so-called torque steer (a torque transmitted to the steering wheel due to the difference between torques produced by the left and right front wheels), based on variations (time-dependent changes) in the rack load caused by rough terrain (irregular road surfaces and road surfaces with steps).

While the vehicle is running straight, furthermore, the steering holding force applied by the driver to the steering wheel may be small or essentially nil, or the driver may not consciously hold the steering wheel. In such a situation, it is expected that the steering wheel angle will be disturbed greatly due to steering kickback and torque steer based on variations in the rack load caused by rough terrain (irregular road surfaces and road surfaces with steps).

### SUMMARY OF THE INVENTION

It is an object of the present invention to provide an electric power steering apparatus which is capable of effectively minimizing or blocking fluctuations of the steering force on the steering wheel which result from variations in the rack load caused by rough terrain (irregular road surfaces, etc.) when a vehicle incorporating the electric power steering apparatus travels thereon.

An electric power steering apparatus for a vehicle according to the present invention includes a rack and pinion mechanism for transmitting a steering force from a steering wheel to road wheels of the vehicle, the rack and pinion mechanism including a rack and a pinion, a drive signal generator for generating a drive signal for generating a steering assistive force depending on steering of the steering wheel, an actuator for generating the steering assistive force and transmitting the steering assistive force through the rack of the rack and pinion mechanism to the road wheels in response to the drive signal, a rack load rate-of-change calculator for calculating a rate of change of a load imposed on the rack, and a corrective signal generator for generating a corrective signal for the drive signal in a direction to cancel out the rate of change of the rack load when the rate of change of the rack load calculated by the rack load rate-of-change calculator becomes equal to or greater than a predetermined value in a case where a steering speed of the steering wheel is equal to or smaller than a predetermined speed, and supplying the corrective signal to the actuator.

The steering speed may be determined indirectly by measuring the rotational speed of the actuator, e.g., an electric motor, or the stroke speed of the rack, rather than directly measuring the steering speed of the steering wheel. Therefore, the steering speed covers the steering speed of the steering wheel, the speed of the actuator, and the stroke speed of the rack.

The predetermined value for the rate of change of the load imposed on the rack may be determined in advance based on experimental data or simulated data produced for each vehicle when the vehicle actually runs. Actual vehicles which incorporate the electric power steering apparatus may include a mechanism for making the predetermined value variable.

According to the present invention, while the steering speed of the steering wheel is equal to or smaller than the predetermined speed, i.e., while the vehicle is making a steady turn with the steering wheel being held at a given angle or while the vehicle is running straight, when the rate of change of the rack load calculated by the rack load rate-of-change calculator becomes equal to or greater than the predetermined value, a corrective signal for a drive signal in a direction to cancel out the rate of change of the rack load is generated and added to a drive signal for generating a normal steering assistive force, and the sum signal is supplied to the actuator. Therefore, the electric power steering apparatus is effective to reduce or block fluctuations of the steering force of the steering wheel due to rough terrain (road surface irregularities) on which the vehicle is traveling.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view, partly in block form, of an electric power steering apparatus according to an embodiment of the present invention;

FIG. 2 is a functional block diagram of a corrective current generator according to a first embodiment of the present invention for the electric power steering apparatus; and

FIG. 3 is a functional block diagram of a corrective current generator according to a second embodiment of the present invention for the electric power steering apparatus.

### DESCRIPTION OF THE PREFERRED EMBODIMENTS

Electric power steering apparatuses according to preferred embodiments of the present invention will be described in detail below with reference to the accompanying drawings.

Like or corresponding parts are denoted by like or corresponding reference numerals throughout views.

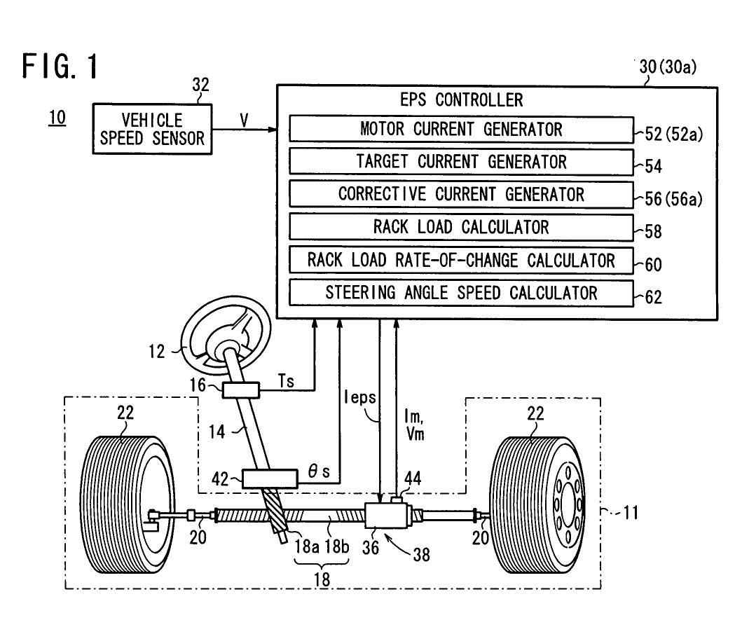

FIG. 1 schematically shows, partly in block form, of an electric power steering apparatus according to the present invention.

As shown in FIG. 1, an electric power steering apparatus 10 according to the present invention is incorporated in a vehicle and has a steering mechanism 11 for steering road wheels 22 (steerable wheels) of the vehicle. The steering mechanism 11 comprises a rack and pinion mechanism 18 including a pinion 18a and a rack 18b, and an assistive rack and pinion mechanism 38 including an EPS (Electric Power Steering) motor 36 which comprises an electric motor.

The driver of the vehicle manually applies a steering force to a steering wheel 12 of the vehicle. The applied steering force is transmitted through a steering shaft 14 to the rack and pinion mechanism 18 of the steering mechanism 11. The steering shaft 14 is associated with a steering torque sensor 16 for detecting a steering torque Ts applied to the steering shaft 14 and a steering angle sensor 42 for detecting a steering angle θs of the steering shaft 14.

When the driver turns the steering wheel 12, the steering shaft 14 rotates the pinion 18a. The rotary motion of the pinion 18a is translated into an axial linear motion of the rack 18b, which causes tie rods 20 to change the direction in which the road wheels 22 (front wheels) run.

To assist in the steering force that is manually applied to the steering wheel 12 by the driver, the steering torque Ts detected by the steering torque sensor 16 is supplied to an EPS controller 30 of the electric power steering apparatus 10.

The EPS controller 30 is also supplied with the steering angle θs from the steering angle sensor 42, a vehicle speed V from a vehicle speed sensor 32, and a motor current Im, a motor voltage Vm, and a motor angular velocity θm′ (dθm/dt where θm represents the angular displacement) [rad/s] from a current/voltage/angular velocity sensor 44 which is mounted on the EPS motor 36. Depending on the supplied items of information, the EPS controller 30 determines a motor current Ieps for assisting in the steering force that is manually applied to the steering wheel 12 and supplies the determined motor current Ieps as a drive signal for generating an assistive torque (steering assistive force).

The EPS controller 30 comprises an ECU (Electronic Control Unit) which is a computing machine including a microcomputer. The ECU has a CPU (Central Processing Unit), a ROM (Read Only Memory, including an EEPROM), a RAM (Random Access Memory), input/output devices including an A/D converter and a D/A converter, a timer as a time measuring means, etc. When the CPU reads and executes programs stored in the ROM, it realizes various functions such as a control section, an arithmetic section, a processing section, etc. These functions may also be implemented by corresponding hardware devices. If the functions are hardware-implemented, then the terms “control section”, “arithmetic section”, “processing section”, etc. are replaced with “control circuit”, “arithmetic circuit”, “processing circuit”, etc., or “control unit”, “arithmetic unit”, “processing unit”, etc. or “control device”, “arithmetic device”, “processing device”, etc.

In FIG. 1, the EPS controller 30 functions as a motor current generator 52, a target current generator 54, a corrective current generator 56, a rack load calculator 58, a rack load rate-of-change calculator 60, and a steering angle speed calculator 62.

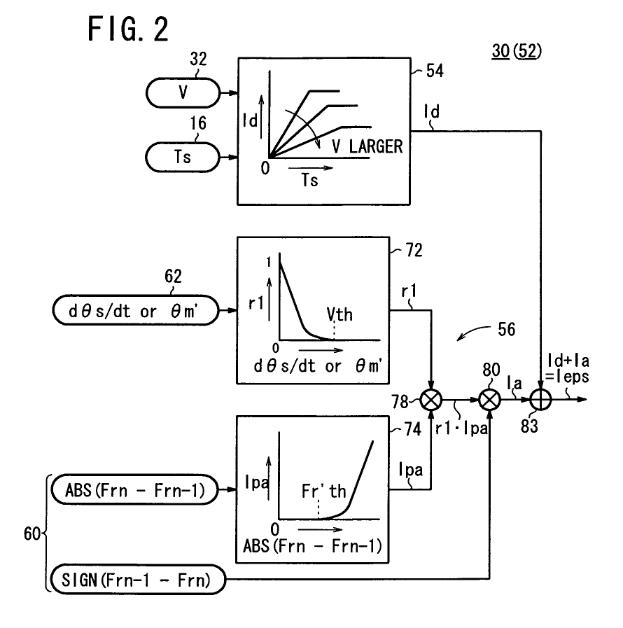

The target current generator 54 has characteristic data (map) 54 shown in FIG. 2, and generates (calculates) a target current Id (corresponding to a target torque for the EPS motor 36) for a steering torque Ts with respect to a vehicle speed V used as a parameter.

The corrective current generator 56 generates a corrective current Ia (to be described later) under a given condition (to be described later). The corrective current Ia and the target current Id (to be described later) are combined into a corrected motor current Ieps (=Id+Ia) and the corrected motor current Ieps is supplied to the EPS motor 36. As described later, the corrective current generator 56 refers to a corrective current generator according to a first embodiment of the present invention, and a corrective current generator 56a refers to a corrective current generator according to a second embodiment of the present invention.

The rack load calculator 58 calculates a rack load Fr according to the equation (1) described above. The equation (1) will be described again below.

Fr=Fp+Fm (1)

where

Fr: rack load

Fp: rack shaft force from the pinion 18a

Fp=steering torque (Ts)÷the pitch circle radius (rp) of the pinion 18a=Ts/rp

Fm: rack shaft force from the EPS motor 36

Fm=output shaft torque Tm of the EPS motor 36×the output gear ratio N of the EPS motor 36=N·Tm

The rack load rate-of-change calculator 60 calculates a rate of change of the rack load as the difference between a rack load Frn−1 calculated in a preceding sampling cycle and a rack load Frn calculated in a present sampling cycle. The rate of change of the rack load is expressed as Fr′=dFr/dt (=Frn−Frn−1). The absolute value of the rate F′ of change of the rack load is represented by ABS(Frn−Frn−1), and the sign of the direction in which the rack load changes is determined as the difference (positive or negative) between the rack load Frn−1 calculated in the preceding sampling cycle and the rack load Frn calculated in the present sampling cycle. Specifically, if the difference (Frn−1−Frn) is positive, then the sign is determined as SIGN(Frn−1−Frn)=+1, and if the difference (Frn−1−Frn) is negative, then the sign is determined as SIGN(Frn−1−Frn)=−1.

As shown in FIG. 2, the rack load rate-of-change calculator 60 shown in FIG. 1 calculates an absolute value ABS(Frn−Frn−1) of the rate of change of the rack load, and a sign SIGN(Frn−1−Frn) of the direction (positive or negative) in which the rate Fr′ of change of the rack load changes. The sign SIGN(Frn−1−Frn) of the direction in which the rate Fr′ of change of the rack load changes may be replaced with the direction in which the steering torque Ts from the steering torque sensor 16 changes.

The steering angle speed calculator (steering angle rate-of-change calculator) 62 calculates a steering angle speed (a steering speed of the steering wheel 12) dθs/dt=θs′ which represents a rate of change of the steering angle θs from the steering angle sensor 42. The steering angle speed dθs/dt can also be calculated using data from a motor rotational speed sensor combined with the EPS motor 36.

### A. Description of a First Embodiment

FIG. 2 is a functional block diagram showing the configuration of the EPS controller 30 (the motor current generator 52) including the corrective current generator 56 according to a first embodiment of the present invention.

According to the first embodiment, the EPS controller 30 determines the motor current Ieps as the sum of the target current Id generated by the target current generator 54 and the corrective current Ia generated by the corrective current generator 56.

The target current generator 54 generates (calculates) a target current Id (corresponding to a target torque for the EPS motor 36) for a steering torque Ts with respect to a vehicle speed V used as a parameter, based on the characteristic data that are present in the target current generator 54, as shown in FIG. 2.

The corrective current generator 56 comprises a speed ratio map 72 having such characteristics which are representative of a first ratio (a first corrective coefficient, a first gain) r1 which progressively decreases from a value “1” to a value “0” as the steering angle speed dθs/dt or motor angular velocity θm′ [rad/s] calculated by the steering angle speed calculator 62 increases from a value “0” to a predetermined speed (threshold speed) Vth, a rack load rate-of-change corrective current map 74 having such characteristics which are representative of a basic corrective current Ipa which progressively increases as the absolute value ABS(Frn−Frn−1) of the rate of change of the rack load increases beyond a predetermined value (threshold) Fr′th (Fr′ refers to the rate of change of a rack load, Fr′th>0), a multiplier 78 for multiplying the first ratio r1 by the basic corrective current Ipa, and a multiplier 80 for multiplying the product from the multiplier 78 by a positive or negative sign to calculate a corrective current Ia. The corrective current generator 56 calculates a corrective current Ia according to the following equation (2):

Ia=r1×Ipa×(1 or −1) (2)

According to the first embodiment, basically, as the steering angle speed dθs/dt or motor angular velocity θm′ (dθm/dt) [rad/s] is smaller, i.e., as the steering wheel is in a state closer to the state in which it is being held at a given angle by the driver, the first ratio r1 is increased based on the speed ratio map 72. When the rack load Fr increases in the rack load rate-of-change corrective current map 74 {(Frn−1−Frn)<0→SIGN(Frn−1−Frn)=−1}, as the absolute value ABS(Frn−Frn−1) of the rate of change of the rack load increases beyond the predetermined value (threshold) Fr′th (Fr′ refers to the rate of change of a rack load, Fr′th>0), the corrective current generator 56 generates a corrective current Ia {Ia<0} (Ia=r1·Ipa<0) in a direction to reduce an increase in the steering force of the steering wheel 12. The adder 83 adds the corrective current Ia (whose value is negative) to the target current Id to generate a motor current Ieps, which is supplied to the EPS motor 36.

When the steering mechanism 11 is thus controlled, torque fluctuations of the steering wheel 12 due to kickback from the road surface can be reduced.

Similarly, as the steering angle speed dθs/dt or motor angular velocity θm′ (dθm/dt) is smaller, i.e., as the steering wheel is in a state closer to the state in which it is being held at a given angle by the driver, the first ratio r1 is increased based on the speed ratio map 72. When the rack load Fr decreases in the rack load rate-of-change corrective current map 74 {(Frn−1−Frn)>0→SIGN(Frn−1−Frn)=1}, as the absolute value ABS(Frn−Frn−1) of the rate of change of the rack load increases beyond the predetermined value Fr′th, the corrective current generator 56 generates a corrective current Ia {Ia>0} (Ia=r1·Ipa>0) in a direction to reduce a decrease in the steering force of the steering wheel 12. The adder 83 adds the corrective current Ia (whose value is positive) to the target current Id to generate a motor current Ieps, which is supplied to the EPS motor 36.

When the steering mechanism 11 is thus controlled, torque fluctuations of the steering wheel 12 due to kickback from the road surface can be reduced.

### B. Description of a Second Embodiment

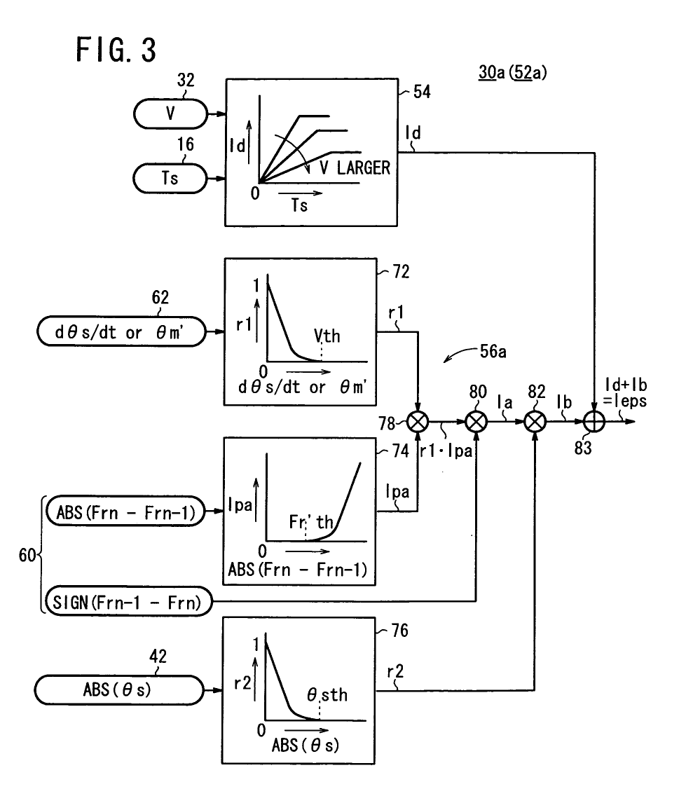

FIG. 3 is a functional block diagram showing the configuration of an EPS controller 30a (motor current generator 52a) including the corrective current generator 56a according to a second embodiment of the present invention.

The corrective current generator 56a according to the second embodiment further includes a steering angle ratio map 76 having such characteristics which are representative of a second ratio (a second corrective coefficient, a second gain) r2 which progressively increases from a value “0” to a value “1” as the absolute value ABS(θs) of the steering angle θs drops from a predetermined value (threshold) θsth, and a multiplier 82 for calculating a corrective current Ib by multiplying the corrective current Ia calculated according to the first embodiment by the second ratio r2, according to the following equation (3):

Ib=Ia×r2=r1×r2×Ipa×(1 or −1) (3)

While the vehicle is running straight, i.e., while the driver is applying a small steering holding force or no steering holding force at all, the steering wheel 12 tends to be disturbed greatly due to kickback from the road surface. According to the second embodiment, when the steering angle θs is small, i.e., when the absolute value ABS(θs) thereof is small, in order to increase a steering reaction force gain for reducing kickback, the second corrective coefficient (second gain) r2 is controlled to approach the value “1” to increase the corrective current Ib as the steering angle θs is smaller or the steering wheel 12 is closer to its neutral position. In other words, while the vehicle is running straight, the second corrective coefficient (second gain) r2 which refers to a gain for the corrective signal Ia, is controlled so as to be maximized for thereby reducing torque fluctuations of the steering wheel 12 which tends to be subject to kickback from the road surface while the vehicle is running straight.

### C. Brief Summary of the Invention

As described above, the electric power steering apparatus 10 according to the present invention includes the rack and pinion mechanism 18 for transmitting the steering force from the steering wheel 12 to the road wheels 22, the motor current generator 52 (52a) which serves as a drive signal generator for generating a motor current Ieps as a drive signal for generating a steering assistive force depending on steering of the steering wheel 12, the EPS motor 36 which serves as an actuator for generating a steering assistive force and transmitting the steering assistive force through the rack 18b to the road wheels 22 in response to the motor current Ieps, the rack load rate-of-change calculator 60 for calculating a rate of change per unit time of the load imposed on the rack 18b {(a rate Fr′ (=Frn−Frn−1) of change of the rack load}, and the corrective current generator 56 (56a) which serves as a corrective signal generator for generating a corrective current Ia or a corrective current Ib as a corrective signal for the drive signal in a direction to cancel out the rate Fr′ of change of the rack load when the rate Fr′ of change of the rack load calculated by the rack load rate-of-change calculator 60 becomes equal to or greater than the predetermined value Fr′th in a case where the steering angle speed θs′ (which may be replaced with the motor angular velocity θm′ or the rack stroke speed) which refers to the steering speed of the steering wheel 12 is equal to or smaller than the predetermined speed Vth, and adding the corrective current Ia or the corrective current Ib to the target current Id to produce an EPS current Ieps=Id+Ia or Id+Ib and supplying the EPS current Ieps to the EPS motor 36.

As described above, while the steering angle speed θs′ of the steering wheel 12 is equal to or smaller than the predetermined speed Vth, i.e., while the vehicle is making a steady turn with the steering wheel being held at a given angle or while the vehicle is running straight, when the rate Fr′ of change of the rack load calculated by the rack load rate-of-change calculator 60 becomes equal to or greater than the predetermined value Fr′th, the EPS motor 36 is supplied with the corrective current Ia or Ib which serves as a corrective signal for the drive signal in a direction to cancel out the rate Fr′ of change of the rack load. Accordingly, the steering wheel 12 is prevented from being disturbed due to kickback from the road surface, i.e., the steering force of the steering wheel 12 is prevented from fluctuating.

The predetermined value Fr′th for the rate Fr′ of change of the rack load may be predetermined based on experimental data produced for each vehicle when the vehicle actually runs. Actual vehicles which incorporate the electric power steering apparatus 10 may include a mechanism for making the predetermined value Fr′th variable in order to optimize a steering feel which the driver will have during operation of the electric power steering apparatus 10.

The electric power steering apparatus 10 is thus effective to improve the ability to block fluctuations of the rack load from being transmitted to the steering wheel 12 while the vehicle is making a steady turn, and the like.

Although certain preferred embodiments of the present invention have been shown and described in detail, it should be understood that various changes and modifications may be made therein without departing from the scope of the appended claims.

What is claimed is:

1. An electric power steering apparatus for a vehicle, comprising:
a rack and pinion mechanism for transmitting a steering force from a steering wheel to road wheels of the vehicle, the rack and pinion mechanism including a rack and a pinion;
a drive signal generator for generating a drive signal for generating a steering assistive force depending on steering of the steering wheel;
an actuator for generating the steering assistive force and transmitting the steering assistive force through the rack of the rack and pinion mechanism to the road wheels in response to the drive signal;
a rack load rate-of-change calculator for calculating a rate of change of a load imposed on the rack; and
a corrective signal generator for generating a corrective signal for the drive signal in a direction to cancel out the rate of change of the rack load when the rate of change of the rack load calculated by the rack load rate-of-change calculator becomes equal to or greater than a predetermined value in a case where a steering speed of the steering wheel is equal to or smaller than a predetermined speed, and supplying the corrective signal to the actuator.

2. An electric power steering apparatus for a vehicle according to claim 1, wherein the rack load rate-of-change calculator determines the load imposed on the rack as the sum of a rack shaft force from the pinion of the rack and pinion mechanism and a rack shaft force from the actuator.

3. An electric power steering apparatus for a vehicle according to claim 1, wherein the corrective signal generator sets a gain such that the corrective signal is greater as the steering speed of the steering wheel is smaller.

4. An electric power steering apparatus for a vehicle according to claim 1, wherein the corrective signal generator sets a gain for the corrective signal to a maximum level while the vehicle is running straight.

5. An electric power steering apparatus for a vehicle according to claim 1, wherein the actuator comprises an electric motor.
